(19) United States
(12) Patent Application Publication
(10) Pub. No.: US 2006/0005083 A1
(43) Pub. Date: Jan. 5, 2006

(54) Performance count tracing

(75) Inventors: Michael Joseph Genden, Austin, TX (US); John Samuel Liberty, Round Rock, TX (US); John Fred Spannaus, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: International Business Machines Corporation, Armonk, NY (US)

(21) Appl. No.: 10/881,971

(22) Filed: Jun. 30, 2004

(51) Int. Cl. G06F 11/00

(52) U.S. Cl. 714/47

(57) ABSTRACT

The present invention provides for the hardware on-chip capturing and storage of performance count data about software programs running on the chip. Counters generate performance data about the programs, and the values of the counters are stored in a trace array. In an embodiment, instruction addresses and other data can be written along with the performance count data. In an embodiment, the data can be may be buffered and streamed to an external memory or device. In an embodiment, interval counters control the writing of the performance count data to the trace array.

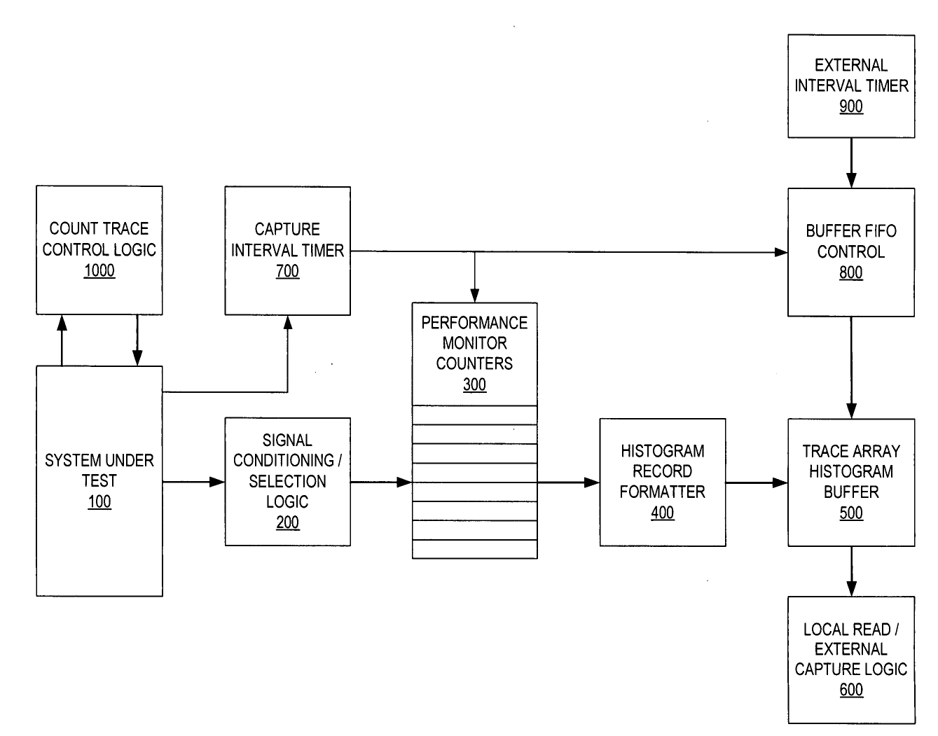

### TECHNICAL FIELD

The present invention relates generally to the performance monitoring of software and, more particularly, to a hardware on-chip method for the performance monitoring of software running on a chip.

### BACKGROUND

To characterize and optimize the performance of a software program, it is necessary to analyze its operation on a chip or other processor or processors. For example, the analysis may disclose that the program consumes many cycles waiting for data to be passed to a processor, or that in a particular loop, there are many mispredictions of branching. These problems can perhaps be fixed, improving the performance of the program.

External monitoring can be used to analyze the performance of a software program. The chip or other processor or processors on which the software is running is programmed to pass data about the operation of the program to pins connected to an external device. Because of the expense of these devices, their availability is very limited. Some developers would be unable to afford them at all. Others may have a very few available. To find a bug that occurs only rarely may require considerable testing time. In addition, the speed of processors can be considerable faster than the connection speed of these external devices. Only a sporadic sample of events can be passed to the external device.

Internal counters may also be used to monitor the performance of a program. These counters, however, also hold only a single value. Further, the use of counters accessible by the operating system can be detrimental to the integrity of the measurements. The utilization of processor, memory, and bus resources both to obtain the counter information and to run the program being measured can change the performance of the program. This impact on the measuring is especially true in the multi-processor chips used in high performance real time gaming systems.

Software monitoring may also be used to monitor the performance of a program. For example, the programmer may add a number of TIME statements to keep track of the time of various sections of the program. Again, the software monitoring may change the performance of the program, especially in programs with very high frequency signals or events that are being monitored.

Therefore, there is a need for a method of monitoring the performance of programs running on a computer that is readily accessible, that allows multiple samples to be taken, and that does not affect the performance of the programs being monitored.

### SUMMARY OF THE INVENTION

The present invention provides for the hardware on-chip gathering and storage of performance count data about software programs running on the chip. Counters generate performance data about the programs, and the values of the counters are stored in a trace array.

### BRIEF DESCRIPTION OF THE DRAWINGS

For a more complete understanding of the present invention and the advantages thereof, reference is now made to the following descriptions taken in conjunction with the accompanying drawing, which shows a block diagram of a system for the hardware on-chip monitoring of software program performance.

### DETAILED DESCRIPTION

In the following discussion, numerous specific details are set forth to provide a thorough understanding of the present invention. However, it will be apparent to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

The drawing is a block diagram of a system for the hardware on-chip monitoring of software program performance. The system under test 100 is a chip or other computer system on which a software program is running. The count trace control logic 1000 controls the monitoring of the software program. The count trace control logic 1000 receives memory mapped IO commands from the processing units of the system under test 100. The count trace control logic 1000 also receives direct signals from the instruction fetch and data fetch units of the processing units to allow triggering the start and stop of count tracing in synchronization with the program flow of the software program. The count trace control logic 1000 also provides for the generation of system interrupts on the occurrence of trace array/histogram buffer 500 overflow and underflow conditions, counter overflow, and interval timeout. The system 100 can be programmed as to which, if any, of those events generates an interrupt. The count trace control logic 1000 also provides a user interface to the software performance monitoring. It interprets parameters supplied by a user to control the software performance monitoring. In an embodiment of the invention, the user supplies codes to certain registers to control the performance monitoring of a software program.

The signal conditioning and selection logic 200 selects which signals generated by the system under test 100 are counted. The signal conditioning and selection logic 200 allows for the selection of a number of signals according to the number of performance monitor counters provided. For example, if there are eight counters to be utilized, then eight signals can be selected from a multitude of performance monitor signals by means of a series of multiplexors that may be distributed throughout the chip. The signal conditioning and selection logic 200 uses a series of edge detectors and polarity changers to allow counting either the number of particular transitions of a signal or the number of cycles that a signal is in a particular state. The signal conditioning and selection logic 200 uses phase masks to allow the counting of signals from alternate clock domains.

The performance monitor counters 300 are one or more counters for keeping count of the signals selected by the signal conditioning and selection logic 200. They can count the number of times that a particular event has occurred or the number of cycles for which an event occurs.

In an embodiment, the performance monitor counters 300 consist of settable 32-bit binary up counters. Each of the performance monitor counters 300 can be configured as a single 32-bit counter or two 16-bit counters. Within a limited silicon area, the user can select 32-bit counters as needed, and utilize the remainder of the silicon area as 16-bit counters. In that way, the user has available a larger number of counters than if they were all configured as 32-bit counters. One or more of the performance monitor counters 300 can be used as count qualifiers for more flexibility in the control of starting and stopping the other counters.

The capture interval timer 700 determines the rate at which the values obtained by the performance monitor counters 300 (performance monitor counter values) are stored in the trace array. When count tracing is enabled, the capture interval timer 700 automatically gets incremented every cycle until reaching the programmed count value, upon which performance monitor counter values and associated address information are stored in the trace array histogram buffer 500 and the capture interval timer 700 resets itself and begins incrementing again.

The histogram record formatter 400 formats the data to be stored in the trace array/histogram buffer 500 and provides the synchronization between the data and the program flow. Addresses can be stored with the data at the capture intervals or can be stored separately in between those intervals. Task specific IDs and reference numbers can also be stored in between the capture intervals as another means of identifying a relationship with program flow. The count values are stored with various numbers of bits per count appropriate to the size of the interval and the potential range of count values. Header information accompanies data entries to distinguish the task and program specific tags and the different performance counter data formats.

The trace array/histogram buffer 500 stores the data formatted by the histogram record formatter 400. The stored data represents a time-based histogram. In an embodiment, the trace array/histogram buffer 500 is an on-chip static random access memory with a width of 128 bits and a depth of 1024 entries.

The buffer FIFO controller 800 controls the flow of data into the trace array/histogram buffer 500. It allows the trace array/histogram buffer 500 to accept real time data at small capture intervals. The trace array 500 is thereby utilized as a FIFO buffer to allow speed smoothing and matching between the data input and the local read/external capture function 600. The buffer FIFO controller 800 provides two modes for the flow of data into the trace array/histogram buffer 500. For the “trace till full” mode, count tracing will proceed from a particular start point until either the trace array is full or the external storage is full, if external capture is enabled. In either case, a buffer full interrupt would be generated at the associated buffer full condition.

In the “tracing till stopped” mode, when external capture is not enabled and the trace array/histogram buffer 500 becomes full, each new array entry will overwrite the oldest entry. When count tracing is stopped, the trace array/histogram buffer 500 will contain the most recent count records. Similarly, when external capture is enabled, the external storage can be treated as FIFO storage. When count tracing is stopped, the external storage will contain the most recent count records.

The local read/external capture logic 600 provides the mechanism to retrieve data from the trace array/histogram buffer 500. When external capture is enabled, the data retrieved from the trace array/histogram buffer 500 is byte serialized and sent to an external interface. A start of record indicator is attached to the data stream. When external capture is not enabled, the data is statically read out through memory mapped IO reads.

The external interval timer 900 provides a mechanism for limiting the peak external rate. This can prevent potential error conditions and loss of data that can occur when the external interface is run at a rate beyond a specific value. Special detection and handling is provided to detect and flag the condition where the average capture/address rate becomes greater than the output rate.

This embodiment of the invention provides a non-invasive monitoring mechanism needed for the performance monitoring and the fine-tuning of the new generation of real time multiprocessor systems on a chip. Storing the formatted histogram data in the trace array/histogram buffer 500 on-chip provides a mechanism that is compatible with the associated high data rates of these chips incurred at the smaller time intervals. These chips are ever more highly integrated with the combination of a multitude of processing units, memory flow controllers, and memory and remote access IO channels. The core clock frequencies have escalated well beyond the capabilities of package IO pin data rates. With this embodiment, real-time passing of the raw signals to external devices is avoided.

The embodiment of the invention also provides a mechanism for gathering the information needed to monitor and improve program performance. The data records contain the necessary information for later association with processor program data flow and for performance analysis. This analysis can provide the basis for both software and hardware performance enhancements. Further, the embodiment gathers the performance data in a non-invasive fashion. The mechanisms used, the performance counters, interval timers, and trace arrays, do not consume resources used by the program being monitored. Thus, the monitoring does not affect the performance of the program.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A system for the hardware on-chip monitoring of software program performance, comprising:
a trace array; and
one or more performance monitor counters, configured to count values associated with the performance of a software program on the chip,
wherein the system is configured to write the count values to the trace array.

2. The system of claim 1, wherein at least one of the counters is configured so that it can be operated as two counters, with a lower limit of total counts.

3. The system of claim 1, wherein at least one counter is configured so that it can be used as a count qualifier.

4. The system of claim 1, further comprising an interval counter, configured so that the values of the one or more performance monitor counters are written to the trace array each interval as determined by the interval counter.

5. The system of claim 1, further comprising one or more phase masks configured to allow the counting of signals from alternate clock domains.

6. The system of claim 1, wherein the system is further configured to store instruction addresses associated with the count values to the trace array.

7. The system of claim 1, further configured for the contents of the trace array to be transferred to external storage.

8. The system of claim 7, further comprising an external interval timer, configured to limit the rate of transfer to external storage to a particular transfer rate.

9. A method for the hardware on-chip monitoring of software program performance on a computer chip, comprising the steps of:
counting the values associated with the performance of the software program on the computer chip; and
writing the values to an on-chip trace array.

10. The method of claim 9, wherein the values are written to the on-chip trace array each interval as determined by the interval counter.

11. The method of claim 9, wherein signals from alternate clock domains are counted.

12. The method of claim 9, wherein writing to the trace array is continued until a counter reaches a particular value.

13. The method of claim 9, wherein writing to the trace array may be programmed to either stop when the trace array becomes full or to continue, overwriting the oldest data.

14. The method of claim 9, further comprising the step of storing instruction addresses associated with the counted values to the trace array.

15. The method of claim 9, further comprising the step of transferring the values to external storage, wherein the trace array is used as a FIFO buffer.

16. The method of claim 15, further comprising the step of limiting the rate of data transfer through an external interface to a specific value.

17. A computer program product for the hardware on-chip monitoring of software program performance on a computer chip, the computer program product having a medium with a computer program embodied thereon, the computer program comprising:
computer code for counting the values associated with the performance of the software program on the computer chip; and
computer code for writing the values to an on-chip trace array.

18. The computer program product of claim 17, wherein the values are written to the on-chip trace array each interval as determined by the interval counter.

19. The computer program product of claim 17, wherein signals from alternate clock domains are counted.

20. The computer program product of claim 17, wherein writing to the trace array is continued until a counter reaches a particular value.

21. The computer program product of claim 17, wherein writing to the trace array may be programmed to either stop when the trace array becomes full or to continue, overwriting the oldest data.

22. The computer program product of claim 17, further comprising computer code for storing instruction addresses associated with the counted values to the trace array.

23. The computer program product of claim 17, further comprising computer code for transferring the values to external storage, wherein the trace array is used as a FIFO buffer.

24. The computer program product of claim 23, further comprising computer code for limiting the rate of data transfer through an external interface to a specific value.
